(19) United States
(12) Patent Application Publication
(10) Pub. No.: US 2026/0172757 A1
(43) Pub. Date: Jun. 18, 2026

(54) ELECTRET CAPACITOR SENSOR AND MANUFACTURING METHOD FOR THE SAME

(71) Applicant: National University Corporation SAITAMA UNIVERSITY, Saitama (JP)

(72) Inventor: Kensuke KAGEYAMA, Saitama (JP)

(73) Assignee: National University Corporation SAITAMA UNIVERSITY, Saitama (JP)

(21) Appl. No.: 19/123,742

(22) PCT Filed: Oct. 20, 2023
(86) PCT No.: PCT/JP2023/037948

§ 371 Date: Apr. 23, 2025

(30) Foreign Application Priority Data
Oct. 24, 2022 (JP) 2022-169863

(51) Int. Cl. H04R 19/01; H04R 31/00

(52) U.S. Cl. CPC H04R 19/016; H04R 31/00

(57) ABSTRACT

An electret capacitor sensor includes: an insulated electrode including a first electrode and an insulating layer; and an electret electrode including a second electrode and an electret layer and arranged such that the electret layer and the insulating layer face each other. The insulating layer includes, on an opposite surface facing the electret layer, protruding parts and bottom parts other than the protruding parts, and the electret electrode is formed having undulations corresponding to the protruding parts and the bottom parts of the insulating layer.

### TECHNICAL FIELD

The present invention relates to an electret capacitor sensor and a manufacturing method therefor.

### BACKGROUND ART

An electret capacitor sensor (ECS) is configured with electret arranged between electrodes (capacitors) arranged facing each other, and an electric field is formed in air gaps inside the capacitor by the electret. In the ECS, when the gaps are deformed by mechanical vibrations, potential difference between the capacitors changes and is converted to an electric signal.

For example, as disclosed in Patent Literature 1, an ECS is known which is equipped with an electret electrode having an upper electrode and an electret layer and an insulated electrode having a lower electrode and an insulating layer, and in which microgaps are formed between the electret layer and the insulating layer. Thereby, it is possible to significantly increase the electric field strength in the gaps, and it becomes possible to perform transmission/reception in a wideband frequency range. Furthermore, since microgaps are much more rigid than macrogaps, pressure resistance is improved, and it is possible to measure vibrations, sounds/ultrasonic waves, and the like not in air but also in water, a living body, and various kinds of materials.

The ECS is suitable for measuring ultrasonic waves that propagate low acoustic impedance like that of a living body in a wideband frequency range. Therefore, the ECS is used for acoustic emission (AE) measurement of plants and microorganisms, and measurement of living-body sounds such as a pulse wave and heart sound.

### CITATION LIST

### Patent Literature

Patent Literature 1: Japanese Patent No. 5305304

### SUMMARY OF INVENTION

### Technical Problem

However, for example, AE of plants and microorganisms is very weak, and acoustic attenuation of media (plant bodies and culture media) is high, and therefore a highly sensitive sensor is required. Further improvement of the sensitivity of the ECS is thus required.

Therefore, the subject of one embodiment of the invention of the present application is to improve the sensitivity of the electret capacitor sensor.

### Solution to Problem

As an embodiment, the present application discloses an electret capacitor sensor that includes: an insulated electrode including a first electrode and an insulating layer; and an electret electrode including a second electrode and an electret layer and arranged such that the electret layer and the insulating layer face each other, wherein the insulating layer includes, on an opposite surface facing the electret layer, protruding parts and bottom parts other than the protruding parts, and the electret electrode is formed having undulations corresponding to the protruding parts and the bottom parts of the insulating layer.

Furthermore, as an embodiment, the present application discloses an electret capacitor sensor, wherein the electret electrode comprises upper parts facing the protruding parts of the insulating layer, lower parts facing the bottom parts of the insulating layer, and side parts connecting the upper parts and the lower parts, the side parts being inclined relative to a protrusion direction of the protruding parts and connecting the upper parts and the lower parts.

Furthermore, as an embodiment, the present application discloses an electret capacitor sensor, wherein first gaps are formed between the bottom parts of the insulating layer and the lower parts of the electret electrode, and chambers having second gaps larger than the first gaps are formed between the protruding parts of the insulating layer and the side parts of the electret electrode.

Furthermore, as an embodiment, the present application discloses an electret capacitor sensor, wherein a width Wg of the bottom parts and a height dr of the protruding parts are formed such that a ratio RC of capacitance of the protruding parts to capacitance of the whole electret capacitor sensor is 0.27 or less.

Furthermore, as an embodiment, the present application discloses an electret capacitor sensor, wherein a width Wg of the bottom parts and a height dr of the protruding parts are formed such that a plastic strain ε of the electret electrode is total elongation of material used for the electret electrode or less.

Furthermore, as an embodiment, the present application discloses an electret capacitor sensor, wherein the insulating layer comprises minute protruding parts smaller than the protruding parts on the bottom parts.

Furthermore, as an embodiment, the present application discloses an electret capacitor sensor, wherein a width Wg of the bottom parts is formed to be 500 times a size dmg of the first gaps or less.

Furthermore, as an embodiment, the present application discloses an electret capacitor sensor, wherein the protruding parts are in at least one of a ridge shape, a pillar shape, a hemispherical shape, a spherical shape, or a grid shape.

Furthermore, as an embodiment, the present application discloses a manufacturing method for an electret capacitor sensor, the manufacturing method comprising the steps of: forming protruding parts and bottom parts other than the protruding parts on an insulating layer of an insulated electrode, the insulated electrode comprising a first electrode and the insulating layer; arranging an electret electrode including a second electrode and an electret layer such that the electret layer and the insulating layer face each other; and pressing the electret electrode against the insulated electrode to deform the electret electrode so that undulations corresponding to the protruding parts and the bottom parts of the insulating layer are formed.

### Effect of Invention

According to one embodiment of the invention of the present application, it is possible to improve the sensitivity of an electret capacitor sensor.

### BRIEF DESCRIPTION OF DRAWINGS

FIG. 1 is a sectional view showing an overview of an electret capacitor sensor of the present embodiment.

FIG. 2 is a diagram showing an electret capacitor sensor manufacturing method of the present embodiment.

FIG. 3A is a diagram showing an example of protruding parts of the electret capacitor sensor of the present embodiment.

FIG. 3B is a diagram showing an example of the protruding parts of the electret capacitor sensor of the present embodiment.

FIG. 3C is a diagram showing an example of the protruding parts of the electret capacitor sensor of the present embodiment.

FIG. 3D is a diagram showing an example of the protruding parts of the electret capacitor sensor of the present embodiment.

FIG. 3E is a diagram showing an example of the protruding parts of the electret capacitor sensor of the present embodiment.

FIG. 4A is a sectional view showing an overview of a modification of the electret capacitor sensor of the present embodiment.

FIG. 4B is a sectional view showing an overview of a modification of the electret capacitor sensor of the present embodiment.

FIG. 5 is a sectional view showing an overview of a modification of the electret capacitor sensor of the present embodiment.

FIG. 6A is a diagram schematically showing an adhesion state of the protruding parts of the electret capacitor sensor of the present embodiment.

FIG. 6B is a diagram schematically showing an adhesion state of the protruding parts of the electret capacitor sensor of the present embodiment.

FIG. 7 is a sectional view showing an overview of a modification of the electret capacitor sensor of the present embodiment.

FIG. 8A is a diagram for explaining covering of an electret electrode which is plastically deformed.

FIG. 8B is a diagram for explaining covering of the electret electrode which is plastically deformed.

FIG. 9 is a diagram showing an overview of an electret capacitor sensor manufactured as one embodiment.

FIG. 10A is a diagram for explaining performance evaluation of the electret capacitor sensor.

FIG. 10B is a diagram showing an example of a signal output of the electret capacitor sensor.

FIG. 11 is a diagram showing each parameter of the electret capacitor sensor of the present embodiment.

FIG. 12 is a graph showing output voltages of ECS's relative to the width of bottom parts.

FIG. 13 is a graph showing output voltages of the ECS's relative to the height of the protruding parts.

FIG. 14 is a diagram showing actual transformation of an electrode layer and a concept of an approximation model, in the case of plastically deforming the electret electrode.

FIG. 15A is a plan view of an insulated electrode in a case where the protruding parts are ridge-shaped.

FIG. 15B is a plan view of the insulated electrode in a case where the protruding parts are pillar-shaped.

FIG. 15C is a plan view of the insulated electrode in a case where the protruding parts are hemispherical-shaped or spherical shaped.

FIG. 16A is a plan view of an insulated electrode in the case where the protruding parts are ridge-shaped.

FIG. 16B is a plan view of the insulated electrode in the case where the protruding parts are pillar-shaped.

FIG. 16C is a plan view of the insulated electrode in the case where the protruding parts are hemispherical-shaped or spherical-shaped.

FIG. 17 is a graph showing output voltages of the ECS's relative to pressing loads F (N) on the ECS's.

FIG. 18A is a diagram showing sensitivity measurement results of an ECS having PTFE electret and protruding parts 122 after elapse of one week at room temperature and after further being held in a thermostatic furnace of 60° C. for one week (an annealing test).

FIG. 18B is a diagram showing sensitivity measurement results of an ECS not having island-shaped silica electret and the protruding parts after elapse of one week at room temperature and after further being held in the thermostatic furnace of 60° C. for one week (an annealing test).

FIG. 18C is a diagram showing sensitivity measurement results of an ECS having island-shaped electret and the protruding parts 122 after elapse of one week at room temperature and after further being held in the thermostatic furnace of 60° C. for one week (an annealing test).

FIG. 19 is a diagram showing that pseudo-AE measurement was performed in a state of a sensing part being significantly transformed by pressing the ECS against a PTFE round bar.

FIG. 20A is a diagram showing change in the sensitivity of the ECS having island-shaped silica electret but not having the protruding parts to pressing loads.

FIG. 20B is a diagram showing change in the sensitivity of the ECS having island-shaped electret and the protruding parts to pressing loads.

FIG. 21A is a diagram showing TR of an ECS using PTFE electret but not having the protruding parts and the ECS using PTFE electret and having the protruding parts, after the ECS's being held at room temperature for one week.

FIG. 21B is a diagram showing TR of the ECS using PTFE electret but not having the protruding parts and the ECS using PTFE electret and having the protruding parts, after annealing tests (for one week).

FIG. 22 is a sectional view showing an overview of an electret capacitor sensor assembly of the present embodiment.

FIG. 23 is a diagram comparing sensitivities TR of manufactured ECS's by performing measurement similar to that of FIG. 17 for the ECS's.

### DESCRIPTION OF EMBODIMENT

A description will be made below on an electret capacitor sensor of the present embodiment and a manufacturing method therefor with reference to the drawings.

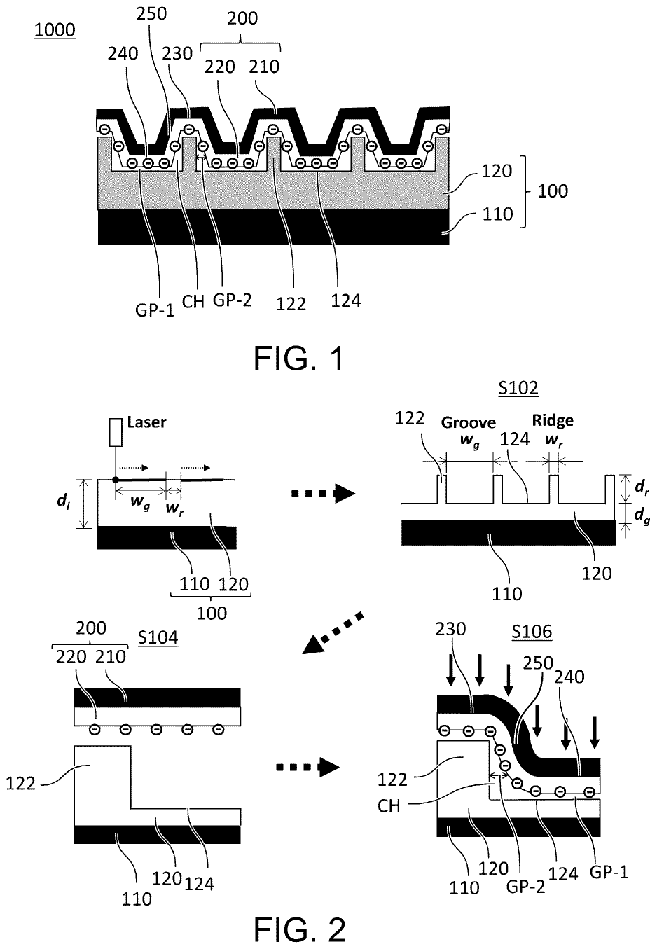

FIG. 1 is a sectional view showing an overview of an electret capacitor sensor of the present embodiment. As shown in FIG. 1, an electret capacitor sensor 1000 includes an insulated electrode 100 that includes a first electrode 110 and an insulating layer 120, and an electret electrode 200 that includes a second electrode 210 and an electret layer 220. The insulated electrode 100 and the electret electrode 200 are arranged such that the electret layer 220 and the insulating layer 120 face each other. The material of the insulating layer 120 and the electret layer 220 can be fluorocarbon resin (PTFE, PFA, FEP, or the like).

As shown in FIG. 1, the insulating layer 120 includes protruding parts 122 and bottom parts 124 other than the protruding parts on an opposite surface facing the electret layer 220. In comparison, the electret electrode 200 is formed having undulations corresponding to the protruding parts 122 and the bottom parts 124 of the insulating layer 120.

More specifically, the electret electrode 200 includes upper parts 230 facing the protruding parts 122 of the insulating layer 120, lower parts 240 facing the bottom parts 124 of the insulating layer 120, and side parts 250 connecting the upper parts 230 and the lower parts 240. The side parts 250 connect the upper parts 230 and the lower parts 240, being inclined relative to the protrusion direction of the protruding parts 122.

Furthermore, in the electret capacitor sensor 1000, first gaps (microgaps) GP-1 are formed between the bottom parts 124 of the insulating layer 120 and the lower part 240 of the electret electrode 200 as shown in FIG. 1. The first gaps GP-1 are, for example, between 10 nm to 10 μm, inclusive. Furthermore, in the electret capacitor sensor 1000, chambers (cavities) CH having second gaps GP-2 larger than the first gaps GP-1 are formed between the protruding parts 122 of the insulating layer 120 and the side parts 250 of the electret electrode 200.

Since the air resistance of the microgaps GP-1 is decreased by the chambers CH, it is possible to improve the sensitivity of the ECS. Furthermore, by forming the protruding parts 122, it is possible to prevent decrease in the sensitivity due to a pressing load. Furthermore, since the surface area of the electret layer 220 increases (the amount of charge retention increases), it is possible to improve charge retention characteristics. Note that the effects of the chambers CH are effective when the microgaps GP-1 are filled with gas such as air, and are not effective when the microgaps GP-1 are sealed with a vacuum.

Next, an electret capacitor sensor manufacturing method will be described. FIG. 2 is a diagram showing an electret capacitor sensor manufacturing method of the present embodiment.

The ECS manufacturing method includes step S102 of forming the protruding parts 122 and the bottom parts 124 other than the protruding parts on the insulating layer 120 of the insulated electrode 100 that includes the first electrode 110 and the insulating layer 120. For example, as shown in FIG. 2, step S102 can be executed by manipulating a CO2 laser with 20 W output at 3000 mm/min against a PTFE layer as the insulating layer 120. That is, by removing the PTFE layer corresponding to areas to be the bottom parts 124 by laser ablation, the protruding parts 122 can be formed. Note that, instead of using a laser, various kinds of methods, such as various kinds of printing methods including screen printing and inkjet printing, lithography, vapor deposition, CVD, ion or plasma irradiation, and press working (press forming of insulated electrode after calcination, press forming at high temperature after burning), can be used to form the protruding parts 122 and the bottom parts 124 on the insulating layer 120.

Furthermore, the ECS manufacturing method includes step S104 of arranging the electret electrode 200 that includes the second electrode 210 and the electret layer 220 such that the electret layer 220 and the insulating layer 120 face each other. Furthermore, the ECS manufacturing method includes step S106 of pressing the electret electrode 200 against the insulated electrode 100 to transform the electret electrode 200 so that undulations corresponding to the protruding parts 122 and the bottom parts 124 of the insulating layer 120 are formed. Step S106 can be executed, for example, by pressing the electret electrode 200 against the insulated electrode 100 with a 40-50 N force using fingers to plastically deform the electret electrode 200 along the protruding parts 122 and the bottom parts 124.

According to the ECS manufacturing method described above, in the side surfaces of the protruding parts 122, the insulated electrode 100 and the electret electrode 200 are not parallel. On the bottom parts 124 side, the distance therebetween increases, and the chambers CH are formed. Thereby, the air resistance of the microgaps GP-1 is reduced, and the amount of charge retention increases. Note that it is desirable that the contact surfaces of the protruding parts 122 adhere to each other (welding, room-temperature curing by adhesive, or heat curing; in the case of heating, it is desirable to heat only the protruding parts 122) though dry-contact is also possible.

As described above, according to the present embodiment, a mechano-electrical conversion element is disclosed in which the electret electrode 200 having the electret layer 220 is stacked on the insulated electrode 100 having the insulating layer 120 regularly provided with the protruding parts 122, and which includes the 10 nm to 10 μm microgaps GP-1 on the bottom parts 124 and includes the chambers CH in the side surfaces of the protruding parts 122.

Furthermore, according to the present embodiment, it is possible to easily form an ECS structure by pressing the electret electrode 200 in a film shape against the insulated electrode 100 after the electret electrode 200 being caused to be electret (after being charged and attached with negative charges) to cause the electret electrode 200 to be permanently deformed (plastically deformed). Here, though the chambers CH themselves contribute to improvement of the sensitivity of the ECS as means for the air in the microgaps GP-1 to escape, the negative charges attached to the electret on the upper parts of the chambers do not have influence on the sensitivity of the ECS almost at all. Since diffusion of the negative charges in the direction to the surface of the microgaps GP-1 can be prevented thereby, the charge retention characteristics (heat resistance and long-term reliability) are improved. Note that, as for the microgaps, they may occur due to the surface roughness of the film, or the insulating layer may be intentionally patterned finely to form spacers.

Furthermore, when the electret electrode 200 vibrates, the microgaps GP-1 is transformed, and conversion to an electric signal occurs thereby. By air going out of and coming into the chambers CH, the air resistance decreases, and the sensitivity is improved. Furthermore, since the equivalent spring stiffness of the microgaps GP-1 is high, and an electric field generated by the electret can be held high, sounds and vibrations can be detected in a wideband frequency range. Furthermore, according to the present embodiment, non-contact acoustic measurement (including ultrasonic waves) and contact vibration and acoustic emission (AE) measurement become possible.

Furthermore, at the time of using the ECS, pressing it against a measurement target (the pressing force can be about 5-50 N), the protruding parts 122 receive most of the static pressing load (the compressive stress), and therefore the compressive stress acting on the microgaps GP-1 decreases. Though, when the microgaps GP-1 are compressed, the equivalent spring stiffness increases, and the sensitivity decreases, this can be avoided. Furthermore, in the case of pressing the ECS against a curved-shaped target such as the stem of a plant to perform measurement, transformation of the ECS is mainly transformation around the protruding parts 122. Therefore, it is possible to prevent excessive transformation of the microgaps GP-1. Thereby, it is possible to prevent decrease in the sensitivity of the ECS (in some cases, improve the sensitivity) in the case of using the ECS, pressing the ECS against a target in any shape. Note that reduction in the static stress on the microgaps GP-1 by the protruding parts 122 is effective even when the microgaps are sealed with a vacuum.

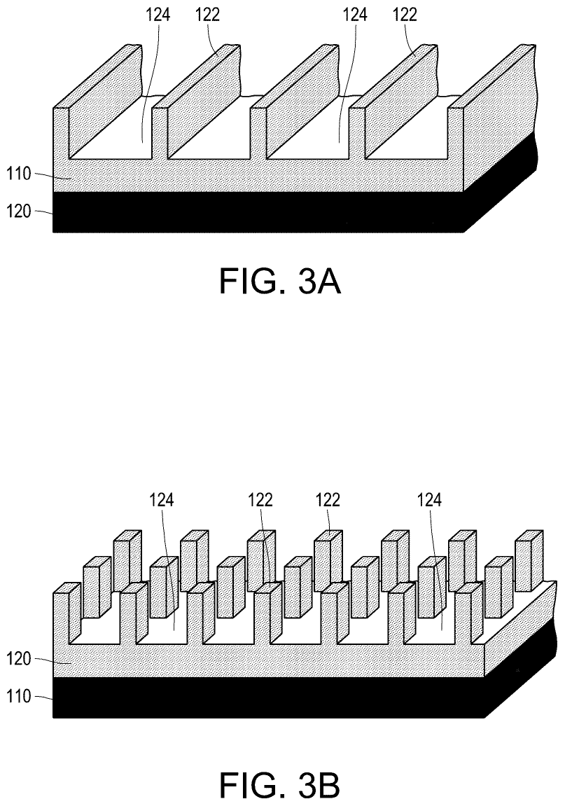

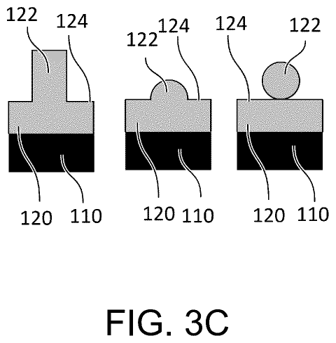

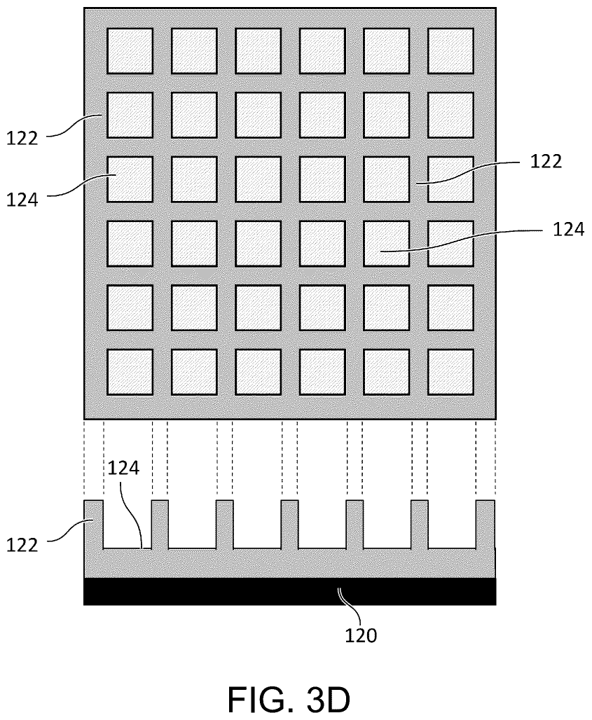

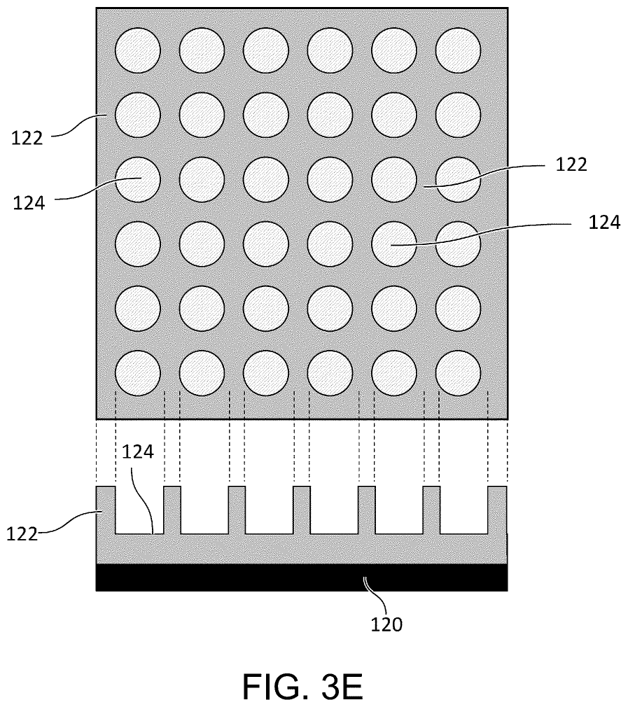

Next, a description will be made on variations of the shapes of the protruding parts 122 and the bottom parts 124. FIGS. 3A to 3E are diagrams showing examples of the protruding parts of the electret capacitor sensor of the present embodiment.

As shown in FIG. 3A, the protruding parts 122 may be ridge-shaped (groove-shaped). Furthermore, as shown in FIG. 3B, the protruding parts 122 may be pillar-shaped. Though FIGS. 3A and 3B show the protruding parts 122 that are quadrilateral-shaped, the protruding parts 122 are not limited thereto and may be hemispherical-shaped or spherical-shaped as shown in FIG. 3C. Note that, since the side surfaces of the protruding parts 122 are somewhat inclined when the protruding parts 122 are formed by laser ablation, the protruding parts 122 may be in a pillar shape (including a needle shape) having slopes (the side surfaces) with an angle other than 90° relative to the bottom parts 124.

FIGS. 3D and 3E show a top view and a side view of the insulated electrode 100. As shown in FIGS. 3D and 3E, the protruding parts 122 may be grid-shaped. In this case, the shape of the bottom parts 124 may be rectangular as shown in FIG. 3D or may be circular as shown in FIG. 3E. Furthermore, the grid pattern of the protruding parts 122 is not limited to only a square grid and may be formed in various patterns such as a triangular grid, a rhombic grid, and a rectangular grid. By forming the protruding parts 122 in a grid shape, the area of the side surfaces of the protruding parts 122 (the chambers CH) per unit area of the microgaps GP-1 increases in comparison with the structures shown in FIGS. 3A to 3C, which is preferable.

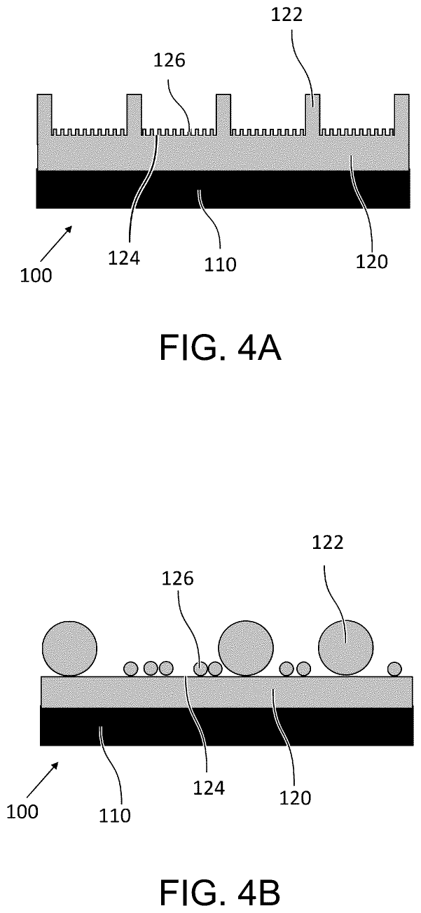

Next, modifications of the ECS will be described. FIGS. 4A and 4B are sectional views showing overviews of modifications of the electret capacitor sensor of the present embodiment.

As shown in FIG. 4A, in the ECS 1000, the insulating layer 120 may have minute protruding parts 126 with a height lower than the height of the protruding parts 122, on the bottom parts 124. By forming the minute protruding parts 126 on the bottom parts 124, it is possible to control the size of the microgaps GP-1. Furthermore, as shown in FIG. 4B, the protruding parts 122 and the minute protruding parts 126 may be formed by distributing different spherical or cylindrical powder grains or fibers in two sizes. In that case, performance improvement can be expected even if the distribution is random, but the performance is further improved by regular arrangement.

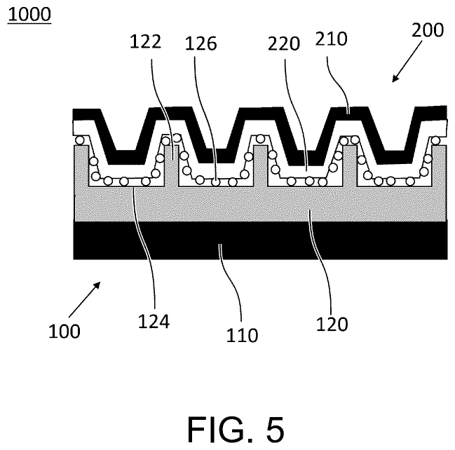

FIG. 5 is a sectional view showing an overview of a modification of the electret capacitor sensor of the present embodiment. As shown in FIG. 5, the minute protruding parts 126 may be formed on the electret layer 220 side by providing electret including island-shaped silica particles (silica agglomerates) on the surface of the electret layer 220. The island-shaped silica particles mean that adjacent silica agglomerates do not adhere to each other and are independent, being at a distance from each other. In the case of using island-shaped silica electret, the island-shaped silica particles can be used as the minute protruding parts 126, and the charge retention characteristics are further improved by the effect of the island-shaped silica particles. In this case, microgaps are also formed in the protruding parts 122, but the performance is influenced little as described later. By forming the island-shaped silica particles, the electret layer 220 can be used as spacers for microgaps (the charge retention characteristics are also improved). Note that, as for the island-shaped silica particles, the content of Japanese Patent No. 6214054 (electret structure and method for manufacturing same, and electrostatic induction-type conversion element) is incorporated in the present application.

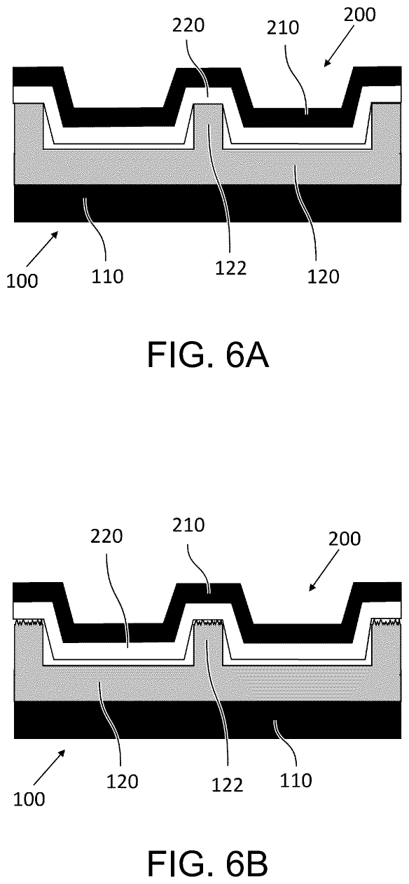

Next, an adhesion state of the protruding parts 122 of the ECS will be described. FIGS. 6A and 6B are diagrams schematically showing adhesion states of the protruding parts of the electret capacitor sensor of the present embodiment.

As shown in FIG. 6A, it is desirable that contact parts between the insulated electrode 100 and the electret electrode 200, on the protruding parts 122, adhere to each other because misalignment between both electrodes caused when a shearing stress acts can be prevented. As for the adhesion, a method of performing welding by instantaneous heating such as flash anneal (diffusion of charges is prevented by short-time heating), a method of performing welding by causing only the protruding parts 122 to be in contact with a heated plate for a short time, ultrasonic bonding by pressing only the protruding parts 122, and the like are conceivable. Note that, though dry contact of only being laminated is also possible between the protruding parts 122 and the electret layer 220, the energy of vibration is transmitted without attenuation when they adhere to each other. Though the electret layer 220 is attached with negative charges (caused to be electret), adhesion is possible by applying adhesive on the protruding parts 122 or by heating areas around the protruding parts 122 for a short time after lamination to perform welding.

On the other hand, as shown in FIG. 6B, even if the contact parts of the insulated electrode 100 and the electret electrode 200 on the protruding parts 122 are in a dry-contact state without adhering to each other, the sensitivity is not influenced much. At the protruding parts 122, the distance between both electrodes is larger than that at the microgaps GP-1, and the capacitance decreases. Therefore, if the ratio RC of the capacitance of the protruding parts 122 to the capacitance of the whole ECS device is sufficiently small, deformation of the areas around the protruding parts 122 does not have influence on the sensitivity almost at all.

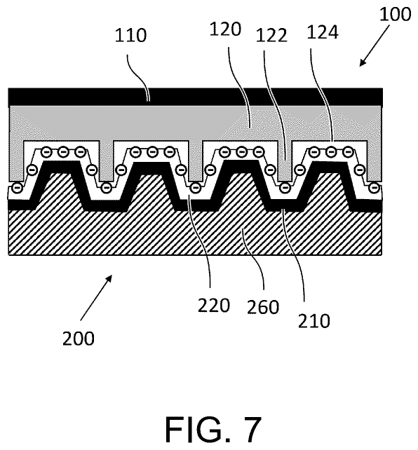

FIG. 7 is a sectional view showing an overview of a modification of the electret capacitor sensor of the present embodiment. As shown in FIG. 7, the electret electrode 200 may include a back layer 260 adhering to the back surface on the opposite side of the electret layer 220 of the second electrode 210. Thus, by causing the back layer 260 to adhere after plastically deforming the electret electrode 200 and stacking it on the insulated electrode 100, it is possible to cause the electret electrode 200 to be a lower electrode.

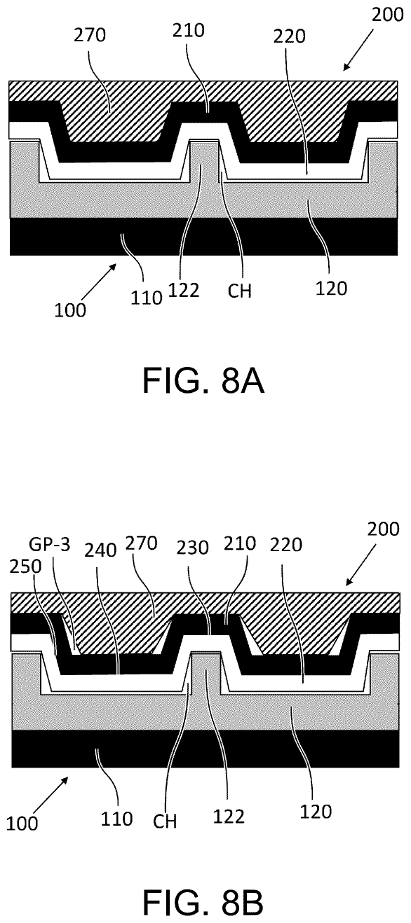

Hereinafter, a description will be made on a case where the electret electrode 200 is plastically deformed as an upper electrode. FIGS. 8A and 8B are diagrams for explaining covering of the electret electrode which is plastically deformed.

In the case of using the ECS in contact with a measurement target, for example, attaching the ECS to the stem of a plant, it is easier for the ECS to be in close contact with the measurement target when the upper electrode is flat. In order to prevent the electrode from being damaged, a protection layer is required. Therefore, as shown in FIG. 8A, the electret electrode 200 may have a covering layer 270 provided by applying resin such as adhesive on the back surface of the second electrode 210. In the ECS according to the present embodiment, since the side surfaces of the protruding parts 122 act as the chambers CH, it is not necessary for a load or vibrations to act thereon. Therefore, the covering layer 270 can be obtained only by applying flexible tape like silicone resin tape. Note that, as shown in FIG. 8B, it is only required that the lower parts 240 of the electret electrode 200 and the covering layer 270 are closely in contact with each other, and it does not matter even if there are gaps GP-3 between the side parts 250 of the electret electrode 200 and the covering layer 270.

In the case of measuring AE using the stem of a plant, it is necessary to press the ECS with a load of about 5-20 N (the sensing part: 8×8 mm; corresponding to a stress of 80-300 kPa) in order to cause the ECS to be in close contact with the stem. When the microgaps of the ECS are compressed by a pressing load, however, the equivalent stiffness of the vibrating part increases due to increase in the air resistance inside the gaps by reduction of the gaps and increase in the density of contact points between the electret layer 220 and the insulating layer 120. Therefore, the sensitivity decreases. Furthermore, when the ECS is pressed against a cylindrical shape like a stem, wrinkles easily appear on the sensing part. When the wrinkles appear, the microgaps are excessively deformed, and therefore the performance significantly decreases.

In comparison, in the case of using the ECS in contact with a measurement target, contact closeness is improved by coating resin on the upper parts of the electret electrode 200 to provide the covering layer 270. In this case, only applying tape on the electret electrode 200 causes gaps to occur between the side parts 250 and the covering layer 270, but the sensitivity of the ECS of the present embodiment is not influenced. Therefore, it is possible to easily protect the surface and improve the contact closeness only by applying silicone resin tape or the like.

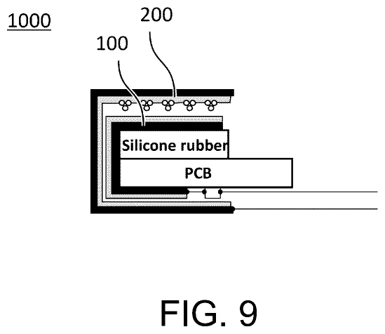

Next, an ECS manufactured as one embodiment will be described. FIG. 9 is a diagram showing an overview of the electret capacitor sensor manufactured as the one embodiment. The ECS of the one embodiment was manufactured as described below.

By spin-coating PTFE dispersion on an Al electrode with a thickness of 11 μm and performing calcination and burning, an insulated electrode 100 with a thickness of 5-12 μm was obtained. Furthermore, by, after forming a PTFE layer with a thickness of 3 μm in a similar procedure, attaching negative charges to a PTFE surface layer by corona discharge, a PTFE electret electrode 200 with a surface potential of 0.36-0.39 kV was obtained. As for the insulated electrode 100, protruding parts were formed by laser ablation between the calcination and the burning. More specifically, by manipulating a CO2 laser with 20 W output at 3000 mm/min to remove the PTFE layer corresponding to areas to be bottom parts by laser ablation, the protruding parts were formed. At this time, a PTFE layer with a thickness of 1.2-1.3 μm remained at the bottom parts, forming an insulating layer. From thickness measurement of samples of only the bottom parts by a micrometer, the size (in the height direction) dmg of microgaps was about 2 μm. Note that, in the case of using PTFE for the insulating layer 120, it is possible to, by performing laser irradiation before performing calcinations and burning, cause ablation to occur with reduced laser output. Therefore, damage to the PTFE is reduced. Furthermore, it is possible to, by using colloidal silica for the insulating layer 120 to distribute minute island-shaped silica particles, cause ablation to occur with reduced laser output because the silica absorbs energy of the laser. Therefore, damage to the insulating layer is reduced. Furthermore, since silica is excellent in insulation, the function of the insulating layer is not lost.

Then, silicone resin with a thickness of 3 mm was placed beneath the insulated electrode 100 as a back layer, and the insulated electrode 100 was attached to a board (PCB) implemented with an FET. Then, the electret electrode 200 was wound to obtain an ECS. The size of the sensing part of the manufactured ECS is 8×8 mm. After winding the electret electrode 200, the electret electrode 200 was plastically deformed along the protruding parts by pressing the electret electrode 200 by fingers with a 40-50 N force. After that, a covering layer was formed by winding silicone resin tape with a thickness of 0.5 mm around the ECS. Note that the insulated electrode 100 may be formed directly on the board (PTFE may be printed on an electrode part of the board). The process up to manufacturing of the insulated electrode may be performed by a MEMS, and then the electret electrode 200 may be stacked thereon (in this case, the weakness of a MEMS microphone that the vibrating part is easily broken is improved).

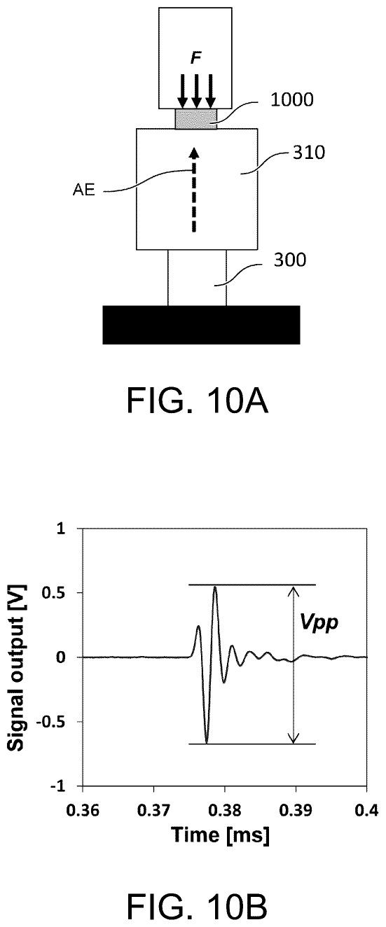

Measurement of pseudo-AE propagating in the silicone resin was performed using the manufactured ECS. FIG. 10A is a diagram for explaining performance evaluation of the electret capacitor sensor. FIG. 10B is a diagram showing an example of a signal output of the electret capacitor sensor.

As shown in FIG. 10A, a piezoelectric sensor 300 as a transmitter and the ECS 1000 were connected, with a silicone resin block 310 interposed therebetween. Then, a burst wave (double amplitude: 0.06 V; frequency: 500 kHz; wave number: 1) was inputted to the piezoelectric sensor 300 to transmit pseudo-AE. The pseudo-AE having propagated through the silicone resin block 310 was received by the ECS 1000, and a signal waveform amplified by a preamplifier (amplification factor: 68 dB; band: 40-400 kHz) was measured. At this time, the centers of the piezoelectric sensor 300 and the ECS 1000 corresponded to the axis of the silicone resin block 310, and the ECS 1000 was pressed in the axial direction. Then, pseudo-AE measurement was performed while a pressing load F was being controlled with a force logger. In FIG. 10B, the horizontal axis indicates time (ms), and the vertical axis indicates output voltage (V) of the ECS 1000. As shown in FIG. 10B, the double amplitude of the measured AE waveform was indicated by Vpp and set as a criterion for sensitivity.

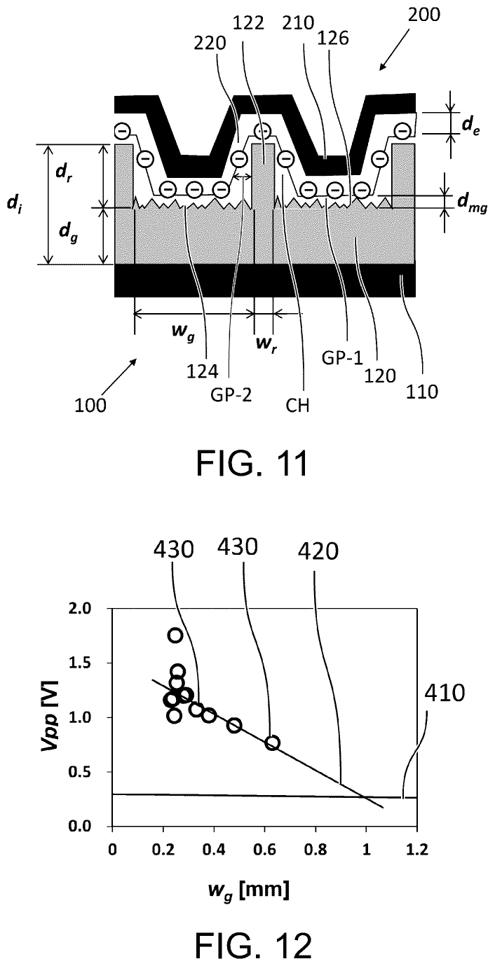

FIG. 11 is a diagram showing each parameter of the electret capacitor sensor of the present embodiment. The following are parameters to be design guidelines for the members of the ECS 1000 having such ridge-shaped protruding parts 122 as are shown in FIG. 3A.
de: thickness of electret layer (excluding island-silica spacer parts)
di: maximum thickness of insulating layer
dg: thickness of bottom parts of insulating layer
dr: height of protruding parts of insulating layer
dmg: size of first gaps (microgaps) (in height direction)
Wr: width of protruding parts
Wg: width of bottom parts
RC: ratio of capacitance of protruding parts to capacitance of the whole ECS device

$$RC = Wr \times dg / ( Wr \times dg + Wg \times di ) = Wr \times dg / \{ ( Wr + Wg ) \times dg + Wg \times dr \}$$

ε: plastic strain of electrode layer to be plastically deformed

$$ε = 2 \times dr / ( Wg + Wr )$$

Next, a description will be made on ranges of the width of the bottom parts 124 (groove width) and the height of the protruding parts 122. FIG. 12 is a graph showing output voltages of ECS's relative to the width of the bottom parts 124. In FIG. 12, the horizontal axis indicates the width Wg (mm) of the bottom parts 124, and the vertical axis indicates output voltage Vpp (V) of the ECS 1000.

A graph 410 in FIG. 12 shows the output voltage Vpp of a conventional type ECS without the protruding parts, using PTFE electret. In comparison, a graph 420 is such that output voltages Vpp of the ECS 1000 of the present embodiment (a plurality of circles 430 in FIG. 12) are linearly approximated by the least squares method.

As shown in FIG. 12, it is seen that, by forming the protruding parts 122 and the bottom parts 124 and undulating the electret electrode 200 correspondingly to the protruding parts 122 and the bottom parts 124, the sensitivity is significantly improved. Furthermore, the sensitivity is improved most around Wg=0.25-0.26. When Wg is too large, the air resistance also increases with increase in flow paths through which the air in the microgaps GP-1 flows to the chambers CH, and the sensitivity decreases. The upper limit of Wg at which performance improvement can be expected is thought to be 1.0 mm when being estimated from the graph 420. This value, however, is highly dependent on the flow paths of the microgaps GP-1. In the experiment result, the sensitivity of the ECS is improved even when Wg is small. When Wg is too small, however, the capacitance of the protruding parts 122 cannot be ignored, and the sensitivity is not improved.

Next, a description will be made on the upper limit of the width Wg of the bottom parts 124. When the width Wg of the bottom parts 124 is too large, the sensitivity of the ECS decreases due to the air resistance in the microgaps GP-1. The chambers CH provided in the side surfaces of the protruding parts 122 serve as means for the air in the microgaps to escape at the time of the microgaps GP-1 being transformed. Thereby, the equivalent spring stiffness of the microgaps decreases, which leads to improvement of the sensitivity. When the width Wg of the bottom parts 124 is too large, however, the air resistance in the flow paths for the air in the microgaps GP-1 to reach the chambers CH cannot be ignored, and the sensitivity is not improved. Since, the upper limit of Wg is 1.0 mm when dmg=2.0 μm, from the experimental conditions, it is preferable that the width Wg of the bottom parts 124 is formed to be 500 times the size dmg of the first gaps GP-1 or less.

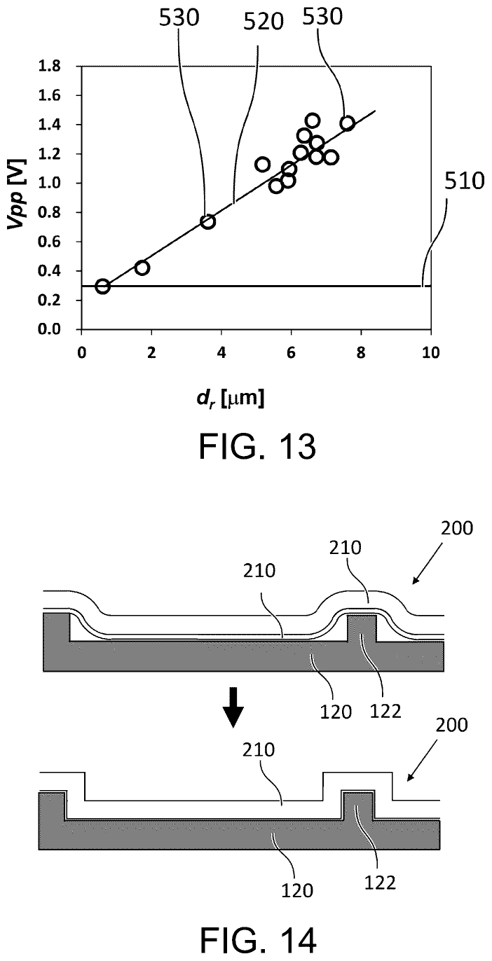

Next, a description will be made on the influence that the height dr of the protruding parts 122 has on the sensitivity. FIG. 13 is a graph showing output voltages of the ECS's relative to the height of the protruding parts. In FIG. 13, the horizontal axis indicates the height dr (μm) of the protruding parts 122, and the vertical axis indicates the output voltage Vpp (V) of the ECS 1000.

A graph 510 in FIG. 13 shows the output voltage Vpp of the conventional type ECS without the protruding parts, using PTFE electret. In comparison, a graph 520 is such that output voltages Vpp of the ECS 1000 of the present embodiment (a plurality of circles 530 in FIG. 13) are linearly approximated by the least squares method.

When the height dr of the protruding parts 122 is too small, the capacitance of the protruding parts 122 cannot be ignored, and the volume of the chambers CH becomes insufficient. Therefore, the sensitivity of the ECS is not improved. The lower limit of dr at which performance improvement can be expected is thought to be 0.8 μm when being estimated from the graph 520. In the experiment result, the sensitivity of the ECS is improved even when dr is large. When dr is too large, however, a strain that exceeds a strain under which electrode material can be plastically deformed (total elongation) occurs at the time of plastically deforming the electrode, and the electrode is broken. This point will be described below.

FIG. 14 is a diagram showing actual transformation of the electrode layer and a concept of an approximation model, in the case of plastically deforming the electret electrode. The upper part of FIG. 14 schematically shows actual deformation of the electret electrode 200, and the lower part of FIG. 14 shows the approximation model of electrode deformation. In the case of plastically deforming the electret electrode 200, it is necessary to give a plastic strain within a range not exceeding the total elongation of the material. The electret layer 220 (fluorocarbon resin and island-shaped silica particles) can be ignored in the case of considering the limit of plastic deformation of the electrode layer because the amount of deformation of the fluorocarbon resin is significantly larger than the material used for the electrode (plastically deformable metal such as Al, Mg, or stainless steel).

In the approximation model of FIG. 14, the plastic strain of the electret electrode 200 is indicated by ε. If ε is not equal to or less than the total elongation of the electrode material, the electret electrode 200 may be broken when being plastically deformed. Therefore, it is necessary to design the height dr of the protruding parts 122 so that ε is equal to or less than the total elongation of the material of the electret electrode 200, which influences the upper limit of dr.

In the case of the ECS of the present embodiment, O material of pure aluminum (Al100) is used as the electrode material, and the total elongation is 0.35. In order to cause ε to be 0.35 or less when Wg=0.25 mm and Wr=0.15 mm, it is necessary to cause dr to be 70 μm or less, and it is the upper limit.

Further, ε also depends on Wg. When the width Wg of the bottom parts 124 is too small, ε may exceed the total elongation of the electrode material, and therefore the lower limit of Wg is also influenced. From the above, it is preferable that the width Wg of the bottom parts 124 and the height dr of the protruding parts 122 are formed such that the plastic strain ε of the electret electrode 200 is equal to or less than the total elongation of the material used for the electret electrode 200.

Next, a description will be made on the lower limits of the width Wg of the bottom parts 124 and the height dr of the protruding parts 122. The distance between the electrodes at the protruding parts 122 is larger than that at the bottom parts 124. Therefore, the electric field strength decreases even if negative charges remain. Furthermore, when the protruding parts 122 are pressed, the microgaps of the protruding parts 122 are compressed. From these factors, the sensitivity has excessively decreased on the protruding parts 122. When the capacitance of the protruding parts 122 is large, the protruding parts 122 have influence on the sensitivity of the whole ECS device as parasitic capacitance.

The ratio of the capacitance of the protruding parts 122 to the capacitance of the whole ECS device is indicated by RC. When RC is too high, the sensitivity is not improved due to the parasitic capacitance of the protruding parts 122. Therefore, the lower limits of the width Wg of the bottom parts 124 and the height dr of the protruding parts 122 depend on RC. In the ECS of the present embodiment, the lower limit of dr is 0.8 μm. At this time, RC is 0.27. From the formula for RC described above, when any of the values of Wg and dr decreases, RC increases. It is necessary to design Wg and dr such that RC is 0.27 or less, which influences the lower limits of Wg and dr. Therefore, it is preferable that the width Wg of the bottom parts 124 and the height dr of the protruding parts 122 are formed such that the ratio RC of the capacitance of the protruding parts 122 to the capacitance of the whole ECS is 0.27 or less.

To summarize the above, design guidelines for Wg and dr are as follows:
(1) Design guidelines for Wg
Wg is to be 500 times dmg or less.
RC is to be 0.27 or less.
ε is to be equal to or less than the total elongation of the material used for electrode layer to be plastically deformed.
(2) Design guidelines for dr
RC is to be 0.27 or less.
ε is to be equal to or less than the total elongation of the material used for electrode layer to be plastically deformed.

Note that, though the design guidelines for Wg and dr have been described as design guidelines which are effective when the protruding parts 122 are ridge-shaped, they can be also applied in a case where the protruding parts 122 are in a shape other than the ridge shape. The design guidelines for Wg and dr are also effective when the protruding parts 122 are pillar-shaped, hemispherical-shaped, spherical-shaped, or grid-shaped as shown below.

As design guidelines for Wg and dr, RC is specified to be 0.27 or less. This is for the purpose of preventing the sensitivity from decreasing due to the parasitic capacitance of the protruding parts 122 when RC, which indicates the ratio of the capacitance of the protruding parts 122 to the capacitance of the whole ECS device, is too high. Since the same phenomenon occurs whichever the shape of the protruding parts is, RC is obtained only by calculating the capacitances of the protruding parts 122 in any shape and the whole ECS device, and it is possible to prevent decrease in the sensitivity by causing RC to be 0.27 or less.

As for a formula for calculating RC at this time, by indicating area ratios (ratios to the whole area) of the protruding parts 122 and the bottom parts 124 in a plan view of the insulated electrode as Ar and Ag, respectively, whichever the shape of the protruding parts is, RC is indicated by the following formula:

$$RC = Ar \times dg / \{ ( Ar + Ag ) \times dg + Ag \times dr \}$$

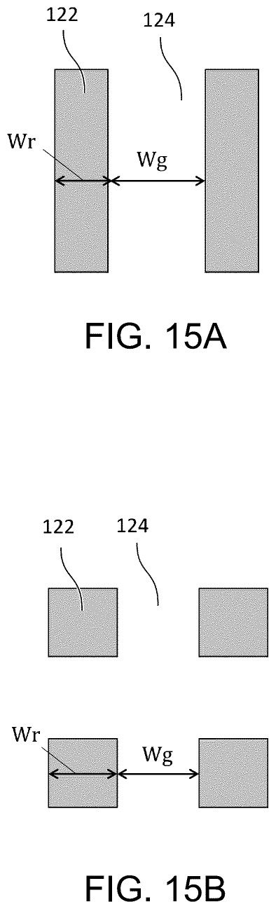

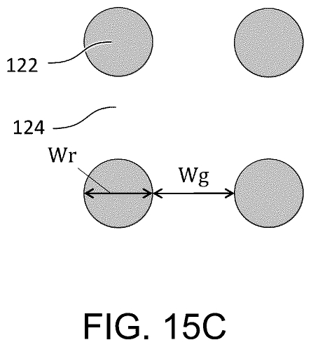

FIG. 15A is a plan view of the insulated electrode 100 in a case where the protruding parts 122 are ridge-shaped. FIG. 15B is a plan view of the insulated electrode 100 in a case where the protruding parts 122 are pillar-shaped. FIG. 15C is a plan view of the insulated electrode 100 in a case where the protruding parts 122 are hemispherical-shaped or spherical-shaped.

As for Ar and Ag, for example,

$$\begin{matrix}Ar = Wr / ( Wr + Wg ) is satisfied in Figure 15 A ; \\ Ar = {Wr}^{2} / {( Wr + Wg )}^{2} is satisfied in Figure 15 B ; \\ Ar = π / 4 \times {Wr}^{2} / {( Wr + Wg )}^{2} is satisfied in Figure 15 C ; and \\ Ag = 1 - Ar is satisified in any of the cases .\end{matrix}$$

In the case where the protruding parts are spherical-shaped or hemispherical-shaped, however, not dr but average height of protruding parts dra=π/4×dr is used instead of dr.

As design guidelines for Wg and dr, ε is specified to be equal to or less than the total elongation of material used for an electrode layer to be plastically deformed, which influences the lower limit of Wg and the upper limit of dr. This is for the purpose of preventing the electret electrode 200 from being broken at the time of being plastically deformed if ε is not equal to or less than the total elongation of the electrode material.

The case of protruding parts in a shape other than the ridge-shape will be considered when ε is calculated. At this time, as for Wr and Wg, a protruding part width and a bottom part width in a direction of adjacent protruding parts being closest to each other are indicated by Wr and Wg as shown in FIGS. 15A, 15B, and 15C. In this direction, the bottom part width is the narrowest, the amount of plastic deformation of the electret electrode is maximized. Therefore, if ε in this direction is equal to or less than the total elongation, it is possible to, in all directions, prevent the electret electrode from being broken due to plastic deformation.

In the case of a hemispherical shape and a spherical shape, when ε is calculated using dr, the value is larger than the amount of deformation that actually occurs. However, since it is possible to, by using the value as a design guideline, prevent the electret electrode from being broken due to plastic deformation, there is no problem.

A description will be made on grounds for the guideline that Wg is to be 500 times dmg or less, among the design guidelines for Wg, being also applicable to shapes other than the ridge shape, with a pillar shape and a hemispherical shape as examples.

When the width Wg of the bottom parts 124 is too large, the air resistance in the flow paths for the air in the microgaps GP-1 to reach the chambers CH cannot be ignored, and the sensitivity is not improved. That is, a bottom part width at a position and in a direction where the flow path is the longest in the microgaps can be set as a reference, being indicated as Wgx.

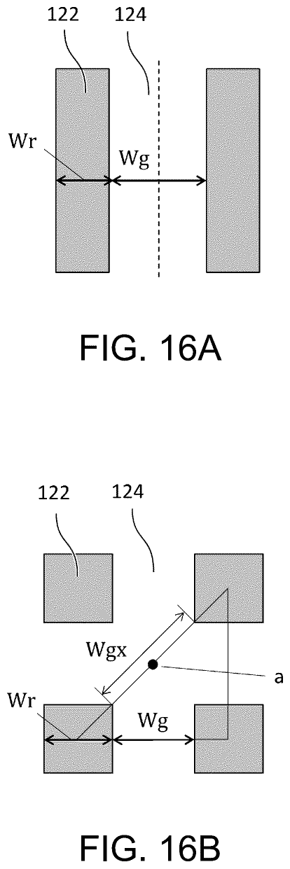

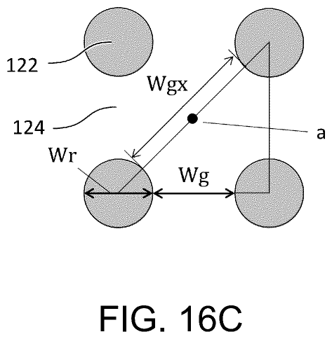

FIG. 16A is a plan view of the insulated electrode 100 in the case where the protruding parts 122 are ridge-shaped. FIG. 16B is a plan view of the insulated electrode 100 in the case where the protruding parts 122 are pillar-shaped. FIG. 16C is a plan view of the insulated electrode 100 in the case where the protruding parts 122 are hemispherical-shaped or spherical-shaped.

In the case where the ridge-shaped protrusions as shown in FIG. 16A are provided, the centerline (the dotted line in the drawing) of the groove-shaped bottom part is a position where the flow path is the longest. Since a bottom part width in a direction in which the flow path is the shortest from this position is Wg, Wgx=Wg is satisfied.

Next, in the case where the pillar-shaped protrusions as shown in FIG. 16B are provided, the center point (“a” in the drawing) of a bottom part surrounded by four protruding parts is the position where the flow path is the longest. Then, twice the shortest distance from this position to a protruding part can be set as Wgx, and Wgx can be calculated by the following formula:

$$Wgx = {2}^{0.5} \times ( Wg + Wr ) - Wr$$

Similarly, in the case where the hemispherical-shaped protrusions as shown in FIG. 16C are provided, the center point (“a” in the drawing) of the bottom part surrounded by four protruding parts is the position where the flow path is the longest. Then, twice the shortest distance from this position to a protruding part can be set as Wgx, and Wgx can be calculated by the following formula:

$$Wgx = {2}^{0.5} \times Wg$$

In the case where protrusions in any other shape are provided, twice the shortest distance from a position where the flow path is the longest to a protruding part can be similarly set as Wgx. In a case where Wg=Wgx is not satisfied, Wg and Wr can be determined such that the condition that Wgx is to be 500 times dmg or less is satisfied.

Note that dg and Wr can be determined according to the design guidelines and required performance and specifications. Literature a shows that it is possible to use thermal nanoimprint to perform machining of grooves with dg=0.01 μm and Wr=80 nm in the case of PET resin, and perform machining of hall-pillar-shaped holes with dg=0.01 μm (hole size) and Wr=0.25 μm in the case of fluorocarbon resin. Furthermore, in Patent Literature 1, the range of dg is specified as 0.01-100 μm. From these results, in the case of forming the protruding parts 122 with fluorocarbon resin, the realistic numerical ranges in which manufacture is possible are: dg=0.01-100 μm and Wr=0.25 μm to 1.0 mm.
Literature a: Naho Kaneko et al., “Surface nano patterning of fluoropolymer and PET sheets by thermal nanoimprint for deposition of functional thin films”, Extended Abstracts for Japan Society of Applied Physics Annual Meetings, The 67th JSAP Spring Meeting, Public Interest Incorporated Association, The Japan Society of Applied Physics, 2020

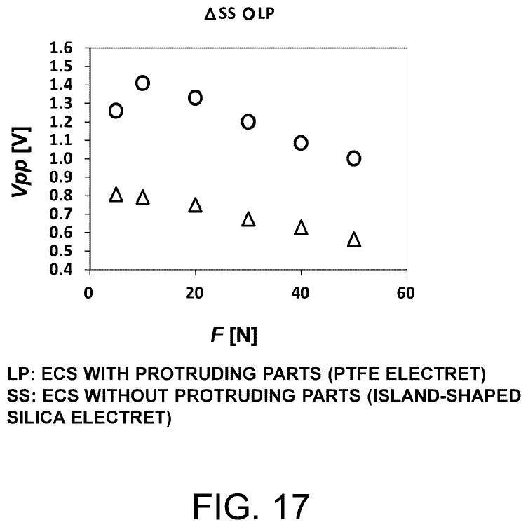

Next, a description will be made on the influence that a pressing load has on the sensitivity of an ECS. FIG. 17 is a graph showing output voltages of ECS's relative to pressing loads F (N) on the ECS's. In FIG. 17, the horizontal axis indicates the pressing load F (N) on the ECS's, and the vertical axis indicates the output voltage Vpp (V) of the ECS 1000.

In FIG. 17, LP indicates change in the sensitivity of an ECS (Wg=0.25 mm, Wr=0.15 mm, dmg=2 μm, dr=7 μm, dg=1.2 μm) having PTFE electret and the protruding parts 122 due to pressing loads. Furthermore, SS indicates change in the sensitivity of an ECS (dmg=3 μm, di=3 μm) not having island-shaped silica electret and the protruding parts due to the pressing loads. When the protruding parts are not provided, the sensitivity of the ECS is improved more by using island-silica electret than using PTFE electret. However, it is seen that, by providing the protruding parts, that the sensitivity of the ECS using PTFE electret is much more improved than the ECS using island-shaped silica electret but not having the protruding parts.

Furthermore, when the protruding parts are not provided, the sensitivity monotonously decreases by the microgaps being compressed as the pressing load increases. By providing the protruding parts 122, however, the sensitivity does not decrease unless a pressing load of 20 N or more is applied. Thus, it is seen that, by providing the protruding parts 122, not only the sensitivity increases due to the existence of the chambers CH but also decrease in the sensitivity due to pressing can be prevented.

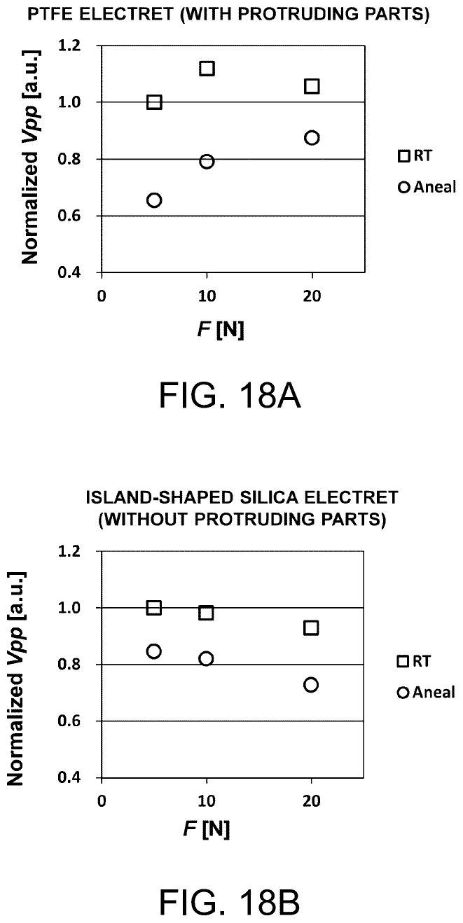

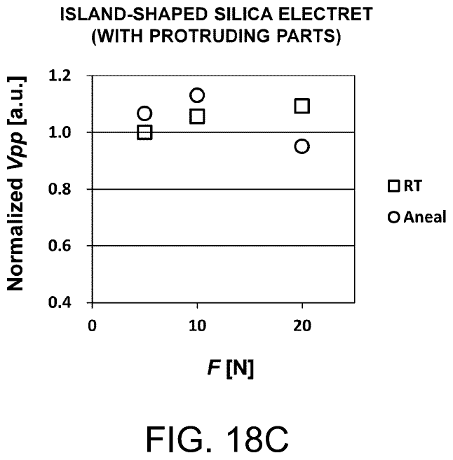

Next, a description will be made on improvement of long-term reliability by the protruding parts and island-shaped electret. FIG. 18A is a diagram showing sensitivity measurement results of an ECS (Wg=0.25 mm, Wr=0.15 mm, dmg=2 μm, dr=7 μm, dg=1.2 μm) having PTFE electret and the protruding parts 122 after elapse of one week at room temperature and after further being held in a thermostatic furnace of 60° C. for one week (an annealing test). FIG. 18B is a diagram showing sensitivity measurement results of an ECS (dmg=3 μm, di=3 μm) not having island-shaped silica electret and the protruding parts after elapse of one week at room temperature and after further being held in the thermostatic furnace of 60° C. for one week (an annealing test). FIG. 18C is a diagram showing sensitivity measurement results of an ECS (Wg=0.25 mm, Wr=0.15 mm, dmg=3 μm, dr=7 μm, dg=1.2 μm) having island-shaped electret and the protruding parts 122 after elapse of one week at room temperature and after further being held in a thermostatic furnace of 60° C. for one week (an annealing test). The annealing test corresponds to an acceleration test for evaluating long-term reliability.

As shown in FIG. 18A, though the sensitivity of the ECS using PTFE electret is significantly improved by having the protruding parts, the sensitivity decreases by 13-35% after the annealing test. In comparison, as shown in FIG. 18B, the sensitivity of the ECS without the protruding parts decreases by 15-28% after the annealing test even though island-silica electret is used, and a significant difference from the ECS having PTFE electret and the protruding parts is not observed in the charge retention characteristics. It is generally known that the charge retention characteristics are improved by using island-shaped silica electret. However, due to the protruding parts being formed, equal charge retention characteristics are also shown even though PTFE electret is used. Furthermore, as shown in FIG. 18C, in the case of the ECS having the protruding parts in addition to island-silica electret, decrease in the sensitivity is 5% at the most, and the charge retention characteristics are significantly improved. Thus, it is possible to manufacture such an ECS that the charge retention characteristics are improved because surplus negative charges are accumulated around the protruding parts by providing the protruding parts 122 and that the charge retention characteristics are significantly improved compared to the past by using island-shaped silica electret.

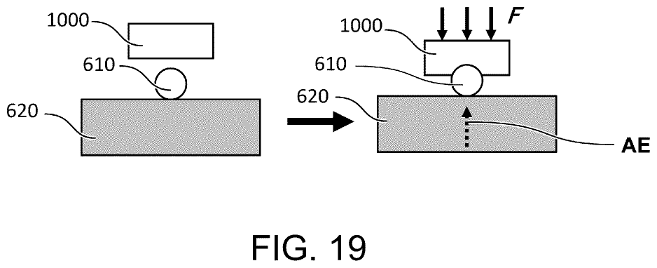

Next, a description will be made on reception sensitivity measurement of an ECS transformed in a curved shape. FIG. 19 is a diagram showing that pseudo-AE measurement was performed in a state of the sensing part being significantly transformed by pressing the ECS against a PTFE round bar. As shown in FIG. 19, by placing a PTFE round bar 610 with a diameter of 10 mm between a silicone resin block 620 and the ECS 1000, and pressing the ECS 1000 to the PTFE round bar 610, pseudo-AE measurement was performed in a procedure similar to the above.

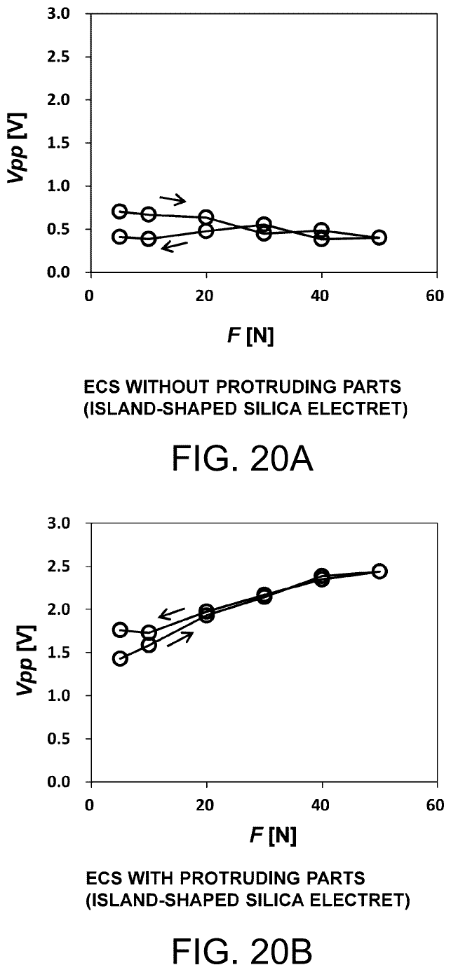

FIG. 20A is a diagram showing change in the sensitivity of the ECS (dmg=3 μm, di=3 μm) having island-shaped silica electret but not having the protruding parts to pressing loads. FIG. 20B is a diagram showing change in the sensitivity of the ECS (Wg=0.25 mm, Wr=0.15 mm, dmg=3 μm, dr=7 μm, dg=1.2 μm) having island-shaped electret and the protruding parts to pressing loads. In FIGS. 20A and 20B, the horizontal axis indicates the pressing load F (N) on the ECS, and the vertical axis indicates the output voltage Vpp (V) of the ECS 1000. FIGS. 20A and 20B show the output voltage Vpp (V) of the ECS 1000 at the time of decreasing the pressing load of the ECS 1000 on the PTFE round bar 610 after increasing the pressing load.

When the pressing load increases, the contact areas among the round bar 610, the ECS 1000 and the silicone resin block 620 increase, and therefore the pseudo-AE easily propagates. In the case of the ECS without the protruding parts, however, the sensitivity slightly decreases even though the pressing load increases, as shown in FIG. 20A. This is because the influence of decrease in the sensitivity due to pressing is strong. Meanwhile, as shown in FIG. 20B, in the case of the ECS 1000 having the protruding parts 122, the sensitivity increases as the pressing load increases, and the increase corresponds to increase in the area of contact with the round bar 610. In AE measurement of a plant, the measurement is performed by pressing the ECS to the stem in a complicated shape. However, by providing the protruding parts 122, it is possible to attach the ECS 1000 to the stem without damaging the sensitivity of the ECS 1000.

Next, a description will be made on transmission/reception measurement of airborne ultrasonic waves. Two ECS's were manufactured under the same conditions in a procedure similar to the above, and transmission/reception measurement of airborne ultrasonic waves was performed, with one of the ECS's as a transmitter and the other as a receiver. The transmitter ECS was not implemented with an FET, and the receiver was installed at a distance of 56 m from the transmitter, facing the transmitter. Then, a burst wave (wavenumber: 5) was inputted to the transmitter to oscillate an ultrasonic wave, and a signal received by the receiver was amplified by a preamplifier (amplification factor: 68 dB; band: 40-400 kHz), and a signal waveform was recorded. Then, transmission/reception sensitivity TR was calculated by subtracting the amplification factor of the preamplifier from an intensity ratio of the frequency spectra of the input waveform and the output waveform.

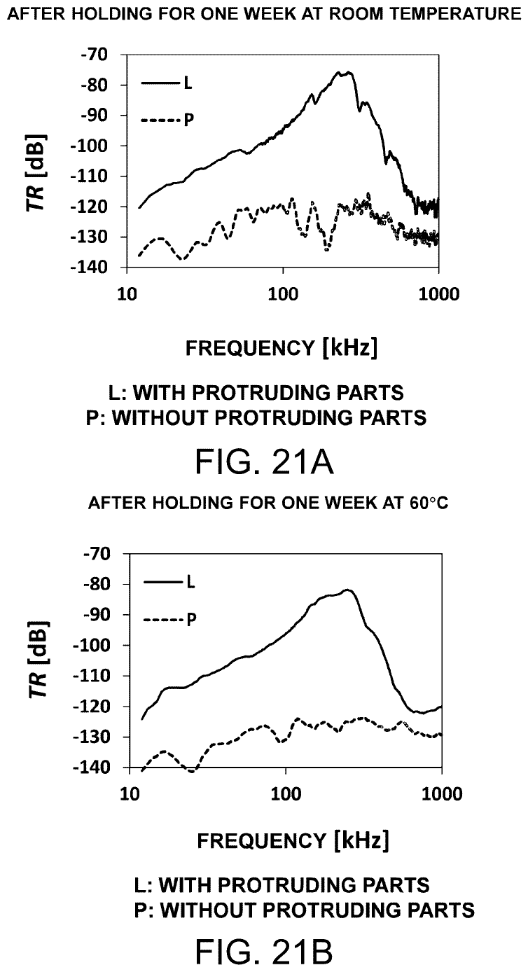

FIG. 21A is a diagram showing TR of the ECS (dmg=2 μm, di=2 μm) using PTFE electret (de=2.5 μm) but not having the protruding parts and the ECS (Wg=0.65 mm, Wr-0.15 mm, dmg=2 μm, dr=7 μm, dg=1.2 μm) using PTFE electret (de=2.5 μm) and having the protruding parts, after the ECS's being held at room temperature for one week. FIG. 21B is a diagram showing TR of the ECS (dmg=2 μm, di=2 μm) using PTFE electret (de=2.5 μm) but not having the protruding parts and the ECS (Wg=0.65 mm, Wr=0.15 mm, dmg=2 μm, dr=7 μm, dg=1.2 μm) using PTFE electret (de=2.5 μm) and having the protruding parts, after annealing tests (for one week).

In FIGS. 21A and 21B, the horizontal axis indicates the frequency (kHz) of the burst wave, and the vertical axis indicates TR (dB). In each of FIGS. 21A and 21B, a graph L indicates TR of the ECS having the protruding parts, and a graph P indicates TR of the ECS not having the protruding parts. As shown in FIGS. 21A and 21B, it is seen that, by providing the protruding parts 122, the transmission/reception sensitivity is significantly improved. Thus, in non-contact acoustic or ultrasonic measurement, the performance of an ECS is also improved by the present embodiment. Furthermore, FIGS. 21A and 21B show the results after holding at room temperature for one week and after the annealing tests similarly to the above, and it is seen that, in the ECS of the present embodiment, TR significantly increases even after the annealing test, and the long-term reliability is also improved.

Furthermore, by providing the protruding parts 122, the transmission output of the transmitter also increases, and significant improvement of the transmission/reception sensitivity as in FIGS. 21A and 21B is achieved, in addition to increase in the reception sensitivity of the receiver. That is, in the case of using an ECS as a transmitter, the electric field strength acting on the microgaps GP-1 of the ECS fluctuates due to the inputted burst wave, and thereby a variable stress occurs on the vibrating part, and vibrations occur. At this time, the transmission output is improved more as the electric field strength of the microgaps GP-1 caused by the electret is higher, and the equivalent spring stiffness of the vibrating part is lower. In this regard, when the protruding parts 122 are provided, the air resistance in the microgaps GP-1 decreases due to the chambers CH, and accordingly, the equivalent spring stiffness of the vibrating part decreases. As a result, the charge retention characteristics of the electret due to surplus negative charges attached to the areas around the chambers are improved, and accordingly, the electric field strength of the electret increases. Thereby, the transmission output is improved. Thus, by providing the protruding parts on an ECS, not only the performance of a receiver but also the performance of a transmitter can be improved.

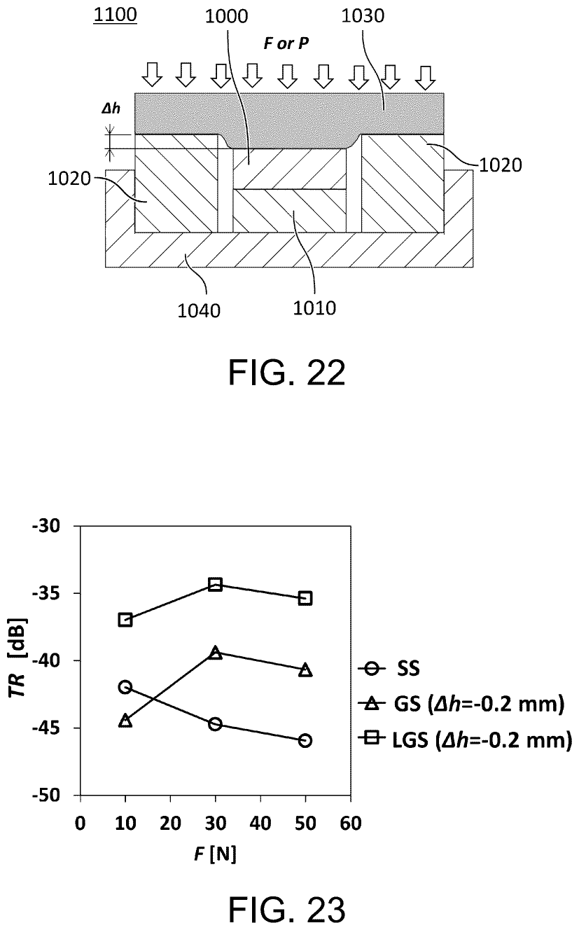

Next, an electret capacitor sensor assembly will be described. FIG. 22 is a sectional view showing an overview of an electret capacitor sensor assembly of the present embodiment.

As shown in FIG. 22, an electret capacitor sensor assembly 1100 includes the ECS 1000 described above, a back layer 1010 attached to the insulated electrode 100 of the ECS 1000, a guard layer 1020 arranged to surround the ECS 1000 and the back layer 1010, and a coupling layer 1030 attached to the electret electrode 200 of the ECS 1000 and the guard layer 1020.

The ECS 1000, the back layer 1010, the guard layer 1020, and the coupling layer 1030 may be integrated and included in a casing 1040. The electret capacitor sensor assembly 1100 is configured to receive the pressing load F or pressure P via the coupling layer 1030.

The guard layer 1020 can be configured with a hard member the transformation of which can be ignored. For example, the guard layer 1020 can be configured with material with hardness equal to or more than 100° of the durometer hardness Type A, and the area of a pressure receiving part (a contact part with the coupling layer 1030) can be adjusted according to the size of the ECS 1000 and the range of the pressing load F or the pressure P.

The back layer 1010 and the coupling layer 1030 can be configured with members that are softer than the guard layer 1020. For example, the back layer 1010 and the coupling layer 1030 can be configured with material with a hardness of 5-70° of the durometer hardness Type A, which is flexible but resilient, like silicone resin. The hardness and thickness thereof can be adjusted according to the range of the pressing load F or the pressure P.

According to the electret capacitor sensor assembly 1100 of the present embodiment, it is possible to improve the pressure resistance of the ECS 1000. That is, the ECS 1000 can be a contactable, low-cost, and wideband AE sensor by providing the microgaps GP-1 as described above. In the case of the ECS 1000 alone, the sensitivity significantly changes by a pressing load exceeding 20 N.

In comparison, according to the electret capacitor sensor assembly 1100 of the present embodiment, it is possible to significantly improve the pressure resistance by arranging the hard guard layer 1020 the deformation of which can be ignored, and the coupling layer 1030 and the back layer 1010 that are flexible but resilient around the ECS 1000 as shown in FIG. 22. For example, in the case of the ECS 1000 having the 8×8 sensing part, the sensitivity decreased when a pressing load exceeding 20 N was received. In the case of electret capacitor sensor assembly 1100, however, the sensitivity did not decrease even when a pressing load exceeding 50 N was received. A description will be made below on an example of an ECS using a guard layer.

### (Example of ECS Using Guard Layer)

An example of manufacturing an ECS having the guard layer 1020 as shown in FIG. 22 will be shown below. An ABC casing 1040 integrated with the guard layer 1020 was manufactured by a 3D printer, and an ECS having the back layer 1010 (silicone resin) with a hardness of 50° and a thickness of 3 mm and the coupling layer 1030 (silicone resin) with a hardness of 10° and a thickness of 3 mm was manufactured. At this time, A difference Δh of the height of the ECS sensing part from the height of the guard layer 1020 shown in FIG. 22 was set as −0.2 mm.

FIG. 23 is a diagram comparing the sensitivities TR of the manufactured ECS's by performing measurement similar to that of FIG. 17 for the ECS's. TR indicates a ratio of Vpp to the double amplitude of a burst wave inputted to a transmitter (the amplification factor of an amplifier has been subtracted).

SS indicates an ECS not having island-shaped silica electret and the protruding parts (equal to SS of FIG. 17); GS indicates an ECS that is SS to which the guard layer 1020 shown in FIG. 22 is added; and LGS indicates an ECS having island-shaped silica electret and the protruding parts to which the guard layer 1020 shown in FIG. 22 is added (an ECS equal to that of FIG. 18C to which the guard layer 1020 is added).

In comparison with SS, the sensitivity of GS is significantly improved when F is 30 N or more, by the guard layer being added. When the load is low (F=10 N), however, the sensitivity decreases. In the case of the low load, the amount of transformation of the coupling layer is small. Furthermore, since the sensing part of the ECS is at a position lower than the guard layer, the pressing force increases only in the central part of the sensing part of the ECS at the low load, and the pressing force is insufficient in the area around the central part. Thereby, the sensitivity decreases. Therefore, the pressure resistance can be improved by adding the guard layer even when the protruding parts are not provided. However, the sensitivity at the low load decreases. Therefore, the range of the load at which high sensitivity can be kept is restricted.

On the other hand, because of having the protruding parts, the sensitivity of LGS is significantly improved in comparison with SS and GS, for the low load to high load. Fluctuation of the sensitivity is within 2 dB, being kept significantly small in comparison with SS and GS. An insulating layer having the protruding parts is more excellent in deformability than an insulating layer not having the protruding parts because the protruding parts are deformed. Therefore, by the central part being significantly deformed, the sensing part is uniformly pressed even at the low load. As a result, LGS has high sensitivity within a wide load range of F=10-50 N. Thus, by using an insulated electrode having the protruding parts and a guard layer together, it is possible not only to achieve sensitivity improvement and pressure resistance improvement but also to significantly increase an applicable pressing load range.

As described above, according to the electret capacitor sensor assembly 1100 of the present embodiment, it becomes possible to firmly attach the ECS 1000 for AE measurement of a plant, and therefore it is possible to easily perform AE measurement of a fruit tree such as a mandarin tree. Furthermore, since pressure resistance against water pressure also increases, it is possible to inexpensively measure bioacoustics in the sea.

### REFERENCE SIGNS LIST

100 insulated electrode
110 first electrode
120 insulating layer
122 protruding part
124 bottom part
126 minute protruding part
200 electret electrode
210 second electrode
220 electret layer
230 upper part
240 lower part
250 side part
1000 electret capacitor sensor
CH chamber (cavity)
GP-1 first gap (microgap)
GP-2 second gap
GP-3 gap

1. An electret capacitor sensor comprising:
an insulated electrode including a first electrode and an insulating layer; and
an electret electrode including a second electrode and an electret layer and arranged such that the electret layer and the insulating layer face each other, wherein
the insulating layer includes, on an opposite surface facing the electret layer, protruding parts and bottom parts other than the protruding parts, and
the electret electrode is formed having undulations corresponding to the protruding parts and the bottom parts of the insulating layer.

2. The electret capacitor sensor according to claim 1, wherein the electret electrode comprises upper parts facing the protruding parts of the insulating layer, lower parts facing the bottom parts of the insulating layer, and side parts connecting the upper parts and the lower parts, the side parts being inclined relative to a protrusion direction of the protruding parts and connecting the upper parts and the lower parts.

3. The electret capacitor sensor according to claim 2, wherein first gaps are formed between the bottom parts of the insulating layer and the lower parts of the electret electrode, and chambers having second gaps larger than the first gaps are formed between the protruding parts of the insulating layer and the side parts of the electret electrode.

4. The electret capacitor sensor according to claim 1, wherein a width Wg of the bottom parts and a height dr of the protruding parts are formed such that a ratio RC of capacitance of the protruding parts to capacitance of the whole electret capacitor sensor is 0.27 or less.

5. The electret capacitor sensor according to claim 1, wherein a width Wg of the bottom parts and a height dr of the protruding parts are formed such that a plastic strain ε of the electret electrode is total elongation of material used for the electret electrode or less.

6. The electret capacitor sensor according to claim 1, wherein the insulating layer comprises minute protruding parts smaller than the protruding parts on the bottom parts.

7. The electret capacitor sensor according to claim 3, wherein a width Wg of the bottom parts is formed to be 500 times a size dmg of the first gaps or less.

8. The electret capacitor sensor according to claim 1, wherein the protruding parts have at least one shape selected from a group consisting of a ridge shape, a pillar shape, a hemispherical shape, a spherical shape, or a grid shape.

9. A manufacturing method for an electret capacitor sensor, the manufacturing method comprising steps of:
forming protruding parts and bottom parts other than the protruding parts on an insulating layer of an insulated electrode, the insulated electrode comprising a first electrode and the insulating layer;
arranging an electret electrode including a second electrode and an electret layer such that the electret layer and the insulating layer face each other; and
pressing the electret electrode against the insulated electrode to deform the electret electrode so that undulations corresponding to the protruding parts and the bottom parts of the insulating layer are formed.

10. The electret capacitor sensor according to claim 2, wherein a width Wg of the bottom parts and a height dr of the protruding parts are formed such that a ratio RC of capacitance of the protruding parts to capacitance of the whole electret capacitor sensor is 0.27 or less.

11. The electret capacitor sensor according to claim 3, wherein a width Wg of the bottom parts and a height dr of the protruding parts are formed such that a ratio RC of capacitance of the protruding parts to capacitance of the whole electret capacitor sensor is 0.27 or less.

12. The electret capacitor sensor according to claim 2, wherein a width Wg of the bottom parts and a height dr of the protruding parts are formed such that a plastic strain ε of the electret electrode is total elongation of material used for the electret electrode or less.

13. The electret capacitor sensor according to claim 3, wherein a width Wg of the bottom parts and a height dr of the protruding parts are formed such that a plastic strain ε of the electret electrode is total elongation of material used for the electret electrode or less.

14. The electret capacitor sensor according to claim 2, wherein the insulating layer comprises minute protruding parts smaller than the protruding parts on the bottom parts.

15. The electret capacitor sensor according to claim 3, wherein the insulating layer comprises minute protruding parts smaller than the protruding parts on the bottom parts.

16. The electret capacitor sensor according to claim 2, wherein the protruding parts have at least one shape selected from a group consisting of a ridge shape, a pillar shape, a hemispherical shape, a spherical shape, or a grid shape.

17. The electret capacitor sensor according to claim 3, wherein the protruding parts have at least one shape selected from a group consisting of a ridge shape, a pillar shape, a hemispherical shape, a spherical shape, or a grid shape.
